(19) United States
(12) Patent Application Publication
(10) Pub. No.: US 2003/0008551 A1
(43) Pub. Date: Jan. 9, 2003

(54) Terminal Jumper with integrated grip handle

(76) Inventor: Che-Chia Chang, Taipei (TW)

Correspondence Address: TROXELL LAW OFFICE PLLC, 5205 Leesburg Pike, Suite 1404, Falls Church, VA, 22041, US

(21) Appl. No.: 09/899,338

(22) Filed: Jul. 5, 2001

(51) Int. Cl. H01R 31/08

(52) U.S. Cl. 439/512

(57) ABSTRACT

The electrical connection jumper with integrated grip handle of the present invention comprises a conductive block encased in a dielectric housing. The housing comprises two sections. One section is the jumper block and the other section is the grip handle. The jumper block section of the housing encases the conductive block and has at least two openings where the conductive block is exposed. These openings allow the jumper to be placed on pins of an electrical connection block so that various settings can be made. The various settings, for example, IRQ, master, slave, or address, are achieved by positioning the jumper over the pins of an electrical connection block thereby electrically coupling the covered pins via the conductive block. The grip handle extends from the jumper block section in order to allow the jumper to be reposition or removed easily. Additionally, the grip handle allows the position of the jumper to be more easily identified visually.

### BACKGROUND OF THE INVENTION

1. Field of Invention

The present invention relates generally to an electrical terminal jumper. More particularly, the present invention relates to an electrical terminal jumper with integrated grip handle.

2. Description of the Related Art

Computer systems commonly contain multiple storage devices such as hard disk drives or cd-rom drives. These storage devices are connected to a computer system motherboard or interface card via a cable. One type of standard electronic interface typically used is the integrated drive electronics (IDE) interface or advanced technology attachment (ATA) interface.

With this interface, two hard disk drives can share the same connecting cable that connects the hard disk drives to the motherboard of the computer. However, in order to share the cable, one of the drives must be configured as a master drive and the other drive must be configured as a slave drive. The drives are configured in this manner in order for the two drives to be distinguished by the motherboard.

In order to configure the master or slave setting, the rear end of the drive has a terminal block consisting of two horizontal rows of metal pins placed above each other. Selecting is achieved by placing a small jumper onto one of the metal pins in the first row and one of the metal pins in the second row. The small jumper is a metal block encased in plastic. Placing the jumper onto the two pins creates an electrical connection between the two pins. Basically, the jumper and terminal block act as a selection switch. Placing the jumper over the two pins in the pin column labeled as master will make that drive the master drive. Placing the jumper over the two pins in the pin column labeled as slave will make that drive the slave drive. In this way, two disk drives can share the same interface cable.

This type of jumper is also used to select input/output (I/O) addresses and interrupt requests (IRQs) on the motherboard or other printed circuit boards.

However, due to the very small size of the jumper, it is extremely difficult to pull the jumper off of the terminal block in order to reposition the jumper in another location. Additionally, if the jumper is on a printed circuit board already installed in the computer, it is almost impossible to remove or reposition the jumper without removing the circuit board due to the small size of the jumper. This is very inconvenient and time consuming for those who need to make adjustments to their computer systems.

As a result, an improved electrical terminal jumper that saves time and is more convenient to remove or reposition is needed.

### SUMMARY OF THE INVENTION

In order to overcome the disadvantages and inconvenience of the conventional electrical connection jumper, the present invention provides an improved electrical connection jumper with integrated grip handle.

The electrical connection jumper with integrated grp handle of the present invention comprises a conductive block encased in a dielectric housing. The housing comprises two sections. One section is the jumper block and the other section is the grip handle. Although the housing is described as comprising two sections for description purposes, the housing is typically a one-piece molded housing.

The jumper block section of the housing encases the conductive block and has at least two openings where the conductive block is exposed. These openings allow the jumper to be placed on pins of an electrical connection block so that various settings can be made The various settings, for example, IRQ, master, slave, or address, are achieved by positioning the jumper over the pins of an electrical connection block thereby electrically coupling the covered pins via the conductive block.

The grip handle extends from the jumper block section in order to allow the jumper to be reposition or removed easily Additionally, the grip handle allows the position of the jumper to be more easily identified visually.

Therefore, the electrical terminal jumper of the present invention overcomes the disadvantages and inconvenience of the conventional electrical connection jumper as well as providing additional advantages that save time and allow the jumper to be conveniently removed, repositioned, and visually identified.

Both the foregoing general description and the following detailed description are exemplary and explanatory only and are not restrictive of the invention, as claimed.

### BRIEF DESCRIPTION OF THE DRAWINGS

The accompanying drawings are included to provide a further understanding of the present invention, and are incorporated in and constitute a part of this specification. The drawings illustrate embodiments of the invention and, together with the description, serve to explain the principles of the invention. In the drawings,

FIG. 1 is an illustration showing an electrical connection jumper in accordance with an embodiment of the present invention; and

FIG. 2 is an illustration showing an electrical connection jumper in accordance with an embodiment of the present invention.

### DETAILED DESCRIPTION OF THE PREFERRED EMBODIMENT

In order to overcome the disadvantages and inconvenience of the conventional electrical connection jumper, the present invention provides an improved electrical connection jumper with integrated grip handle.

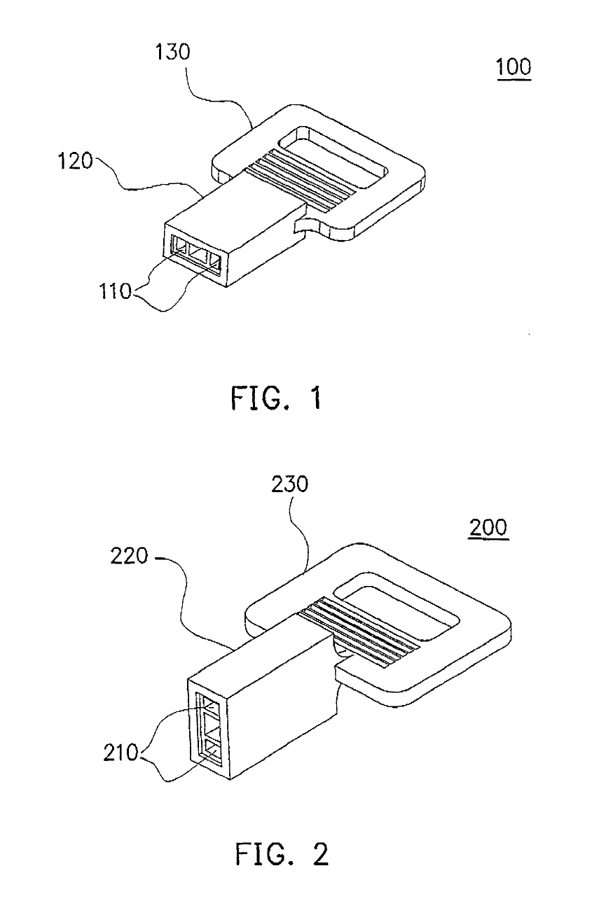

Refer to FIG. 1, which is an illustration showing an electrical connection jumper in accordance with an embodiment of the present invention.

The electrical connection jumper with integrated grip handle 100 of the present invention comprises a conductive block 110 encased in a dielectric housing. The housing comprises two sections. One section is the jumper block 120 and the other section is the grip handle 130. Although the housing is described as comprising two sections for description purposes, the housing is typically a one-piece molded housing.

The jumper block section 120 of the housing encases the conductive block 110 and has at least two openings where the conductive block 110 is exposed. These openings allow the jumper 100 to be placed on pins of an electrical connection block so that various settings can be made. The various settings, for example, IRQ, master, slave, or address, are achieved by positioning the jumper 100 over the pins of an electrical connection block thereby electrically coupling the covered pins via the conductive block 110.

The grip handle 130 extends from the jumper block section 120 in order to allow the jumper 100 to be reposition or removed easily. Additionally, the grip handle 130 allows the position of the jumper 100 to be more easily identified visually.

Refer to FIG. 2, which is an illustration showing an electrical connection jumper in accordance with an embodiment of the present invention.

In another embodiment of the present invention, the grip handle 230 extends in a perpendicular plane from the jumper block section 220. In certain situations, having the grip handle 230 at this angle provides more convenience for repositioning or alignment of the jumper 200.

Note that the grip handle 130 as shown in FIG. 1 and the grip handle 230 as shown in FIG. 2 are not the only positions available. The grip handle may be positioned at other angles or in other positions in order to improve convenience of use in different situations. Additionally, the grip handle shape can be modified in shape and size to improve ease of use. Also, the number and position of housing openings can be modified to accommodate various uses. For example, the housing can have 4 openings in a 2×2 array position to fit over the terminal connection block pins in order to make a selection, In addition, the housing and grip handle can be color-coded for easy identification.

Therefore, the electrical terminal jumper of the present invention overcomes the disadvantages and inconvenience of the conventional electrical connection jumper as well as providing additional advantages that save time and allow the jumper to be conveniently removed, repositioned, and visually identified.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. An electrical connection jumper comprising:
conductive block;
a housing encasing the conductive block, wherein the housing has at least two openings thereby exposing a portion of the conductive block; and
a grip handle integrated into the housing, wherein the grip handle extends from the housing so that the electrical connection jumper can be easily grasped;
wherein the electrical connection jumper electrically couples conductive pins inserted into the at least two openings.

2. The electrical connection jumper of claim 1, wherein the grip handle extends in the same plane as the housing.

3. The electrical connection jumper of claim 1, wherein the grip handle extends in a perpendicular plane as the housing.

4. The electrical connection jumper of claim 1, wherein the housing has two openings.

5. The electrical connection jumper of claim 1, wherein the housing has three openings.

6. The electrical connection jumper of claim 1, wherein the housing and grip handle are molded in one piece.

7. The electrical connection jumper of claim 1, wherein the housing and grip handle are color-coded for identification purposes.
